(19) United States
(12) Patent Application Publication
(10) Pub. No.: US 2003/0190934 A1
(43) Pub. Date: Oct. 9, 2003

(54) Keyboard capable of informing user of incoming call

(76) Inventor: Peter Chen, Taipei (TW)

Correspondence Address: RABIN & BERDO, P.C., Suite 500, 1101 14th Street, N.W., Washington, DC, 20005, US

(21) Appl. No.: 10/117,047

(22) Filed: Apr. 8, 2002

(51) Int. Cl. H04M 1/00

(52) U.S. Cl. 455/567; 455/566

(57) ABSTRACT

A keyboard capable of informing user of incoming call includes a first signal-processing unit powered by a host of a computer to which the keyboard is connected, and a second signal-processing unit powered by the first signal-processing unit. The second signal-processing unit has an input port connected to an antenna for receiving an incoming-call signal, and an output port connected to a display element or a buzzer. The received incoming-call signal may also be sent to the host of the computer via the first signal-processing unit and converted by a supporting application into a message for showing on a screen of the computer. Thus, a user concentrated in working on the computer can be timely informed of calls received on his or her mobile phone.

### BACKGROUND OF THE INVENTION

The present invention relates to a keyboard, and more particularly to a keyboard capable of informing user of incoming call on his or her mobile phone, so that a user concentrated in working on a computer would not miss important calls.

In nowadays rapidly developed industrial society, computer and mobile phone have become two necessary assistants in people's daily life. The computer helps people to complete work more quickly, and the mobile phone is helpful in smooth and successful liaisons necessary for work. People would usually position their mobile phone on a computer table within a hand-reachable distance, and set the ring signal of the mobile phone to low volume, silent with vibrating, or silent with flashing. When a mobile phone user requires a quiet environment to concentrate in working on a computer, he or she would usually become less sensitive to external things, such as the ring signal or flashing light on his or her mobile phone indicating an incoming call. Thus, important calls might be missed. If the ring signal were set to high volume to avoid missing important calls, the concentrated user might be scared by a sudden ring signal. And, if the ring signal were set to low or silent, the user might become distracted from work for worrying about possibly missed incoming calls.

It is therefore tried by the inventor to develop a keyboard that enables a concentrated user to be timely informed of an incoming call received on his or her mobile phone to avoid missing any important call.

### SUMMARY OF THE INVENTION

A primary object of the present invention is to provide a keyboard capable of informing user of incoming call, so that a user concentrated in working on a computer via the keyboard can be timely informed of any incoming call.

To achieve the above and other objects, the keyboard of the present invention mainly includes a first signal-processing unit powered by a host of a computer to which the keyboard is connected, and a second signal-processing unit powered by the first signal-processing unit. The second signal-processing unit has an input port connected to an antenna for receiving an incoming-call signal, and an output port connected to a display element or a buzzer.

The received incoming-call signal may also be sent to the host of the computer via the first signal-processing unit and converted by a supporting application into a message for showing on a screen of the computer. Thus, a user concentrated in working on the computer via the keyboard can be timely informed of incoming calls without missing any one of them.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the structure of a keyboard capable of informing user of incoming call according to a first embodiment of the present invention;

FIG. 2 is a circuit diagram of the keyboard of FIG. 1;

FIG. 3 is a block diagram showing the structure of a keyboard capable of informing user of incoming call according to a second embodiment of the present invention;

FIG. 4 is a circuit diagram of the keyboard of FIG. 3;

FIG. 5 is a block diagram showing the structure of a keyboard capable of informing user of incoming call according to a third embodiment of the present invention; and

FIG. 6 is a circuit diagram of the keyboard of FIG. 5.

### DETAILED DESCRIPTION OF THE PREFERRED EMBODIMENTS

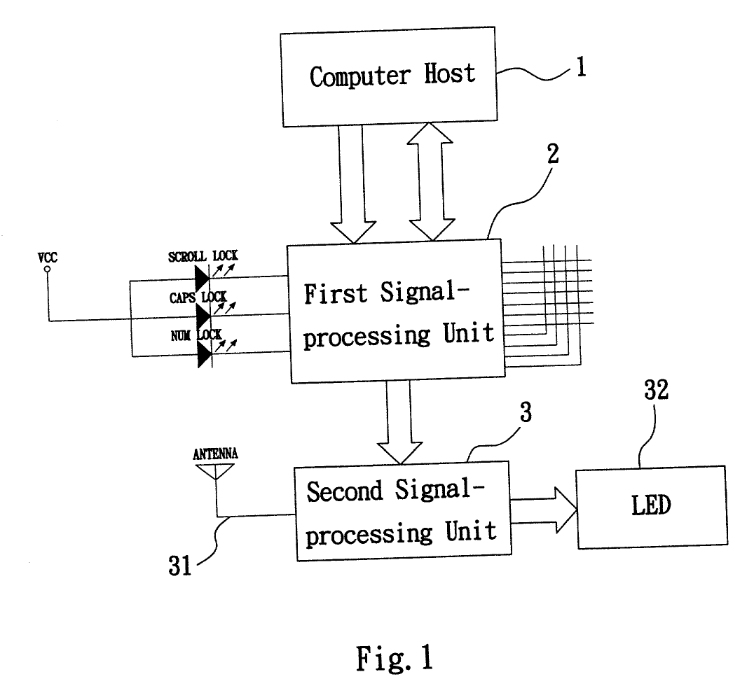

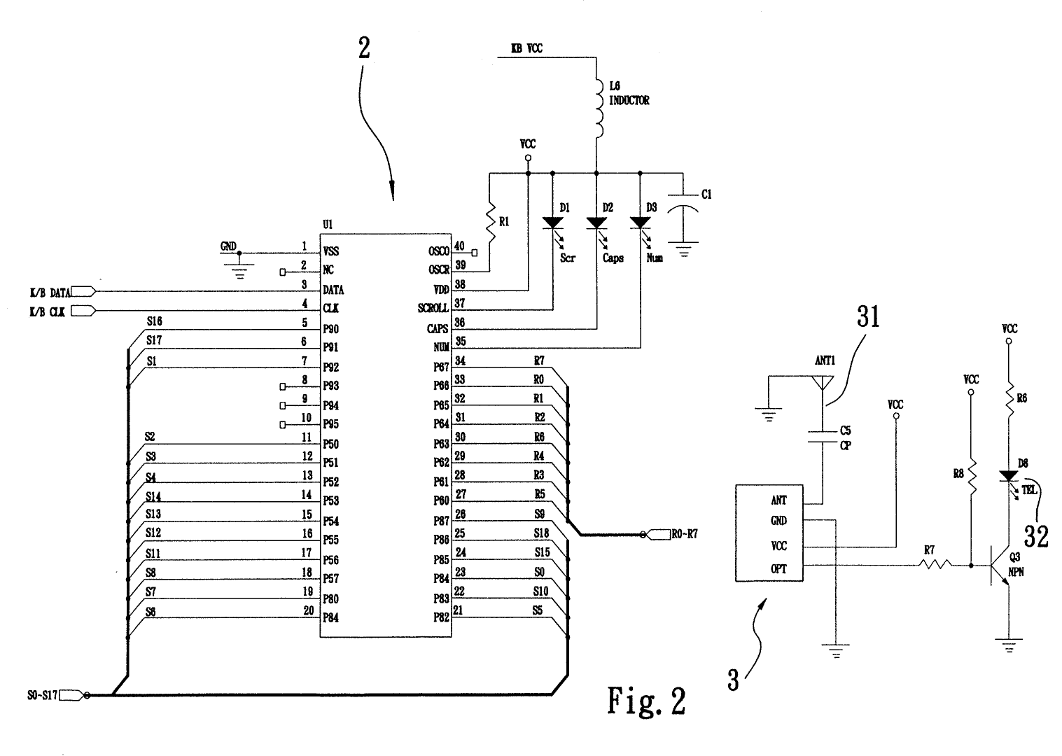

Please refer to FIGS. 1 and 2 that are block and circuit diagrams, respectively, of a keyboard capable of informing user of incoming call according to a first embodiment of the present invention. As shown, the keyboard includes a first signal-processing unit 2 powered by a host 1 of a computer to which the keyboard is connected, so that bi-directional transmission of data between the computer host 1 and the first signal-processing unit 2 is possible. The keyboard is further internally provided with a second signal-processing unit 3 that is powered by the first signal-processing unit 2. The second signal-processing unit 3 is connected at an input port ANT to an antenna 31 that may be a wound wire antenna located at a predetermined place in the keyboard, or a printed copper wire directly molded on a circuit board, or a conductive silver gel directly molded on a soft copper foil, and at an output port OPT with a light emitting diode (LED) 32 that is located at a top surface of the keyboard. When a user's mobile phone receives an incoming call or is in use, the antenna 31 of the second signal-processing unit 3 would receive a signal indicating a line connection between the mobile phone and a telecommunication office or the computer host 1, and the output port of the second signal-processing unit 3 is high. At this point, the LED 32 emits light to inform the user of such line connection, and the user could know directly from the keyboard that his or her mobile phone is receiving an incoming call or is being used to make a call.

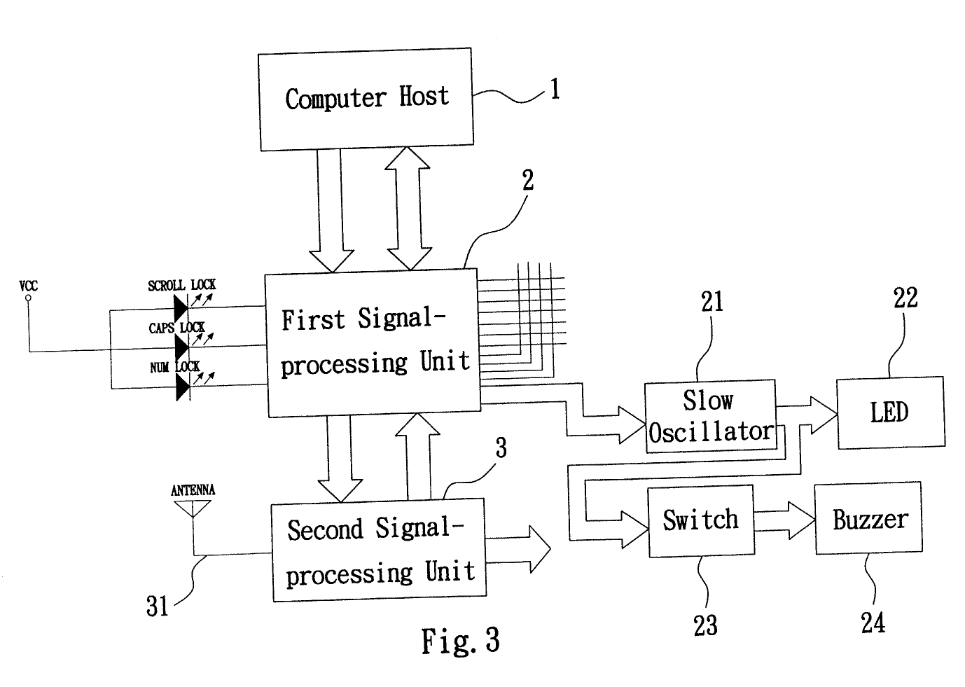

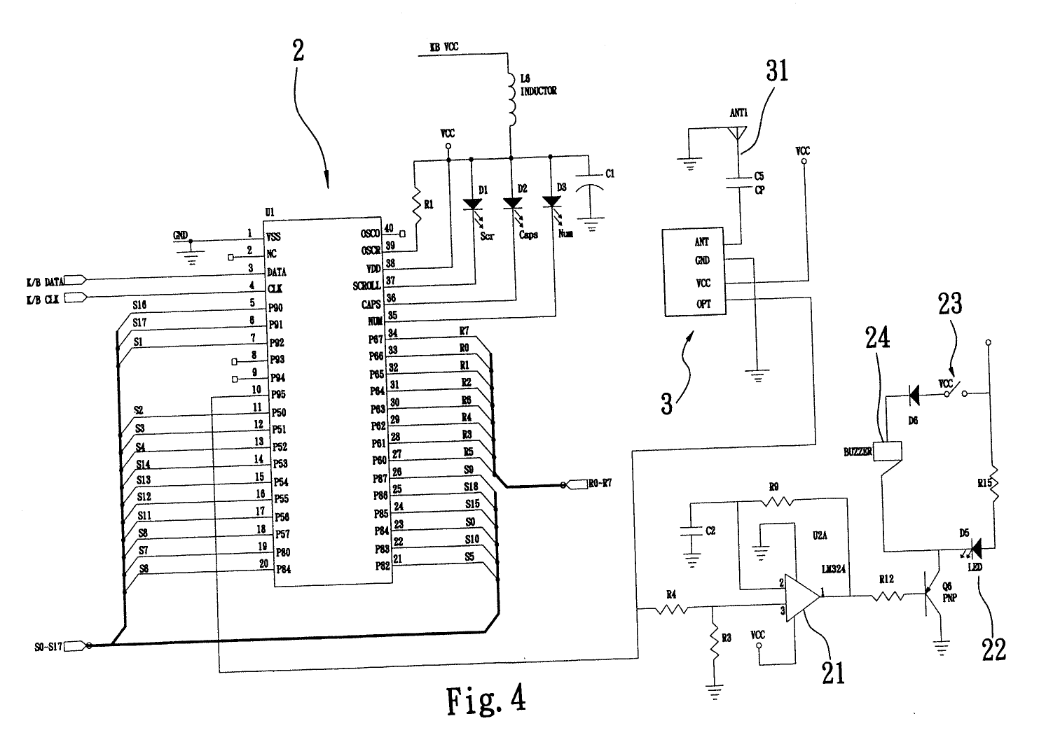

FIGS. 3 and 4 are block and circuit diagrams, respectively, of a keyboard capable of informing user of incoming call according to a second embodiment of the present invention. As shown, the keyboard includes a first signal-processing unit 2 powered by a host 1 of a computer to which the keyboard is connected, so that bi-directional transmission of data between the computer host 1 and the first signal-processing unit 2 is possible. The keyboard is further internally provided with a second signal-processing unit 3 that is powered by the first signal-processing unit 2. The second signal-processing unit 3 has an input port ANT connected to an antenna 31, and an output port OPT connected to the first signal-processing unit 2. The first signal-processing unit 2 has an input signal port to which an LED 22 is connected via a slow oscillator 21, so that the LED 22 flashes when the first signal-processing unit 2 receives a signal. A self-excited buzzer 24 is connected to the slow oscillator 21 via a switch 23. Both the LED 22 and the switch 23 are provided on a top surface of the keyboard, so that a user may select to enable or disable the buzzer 24 simply by setting the switch 23 to a desired position.

The keyboard of the second embodiment employs the same technical principle as that of the first embodiment. However, in the second embodiment of the present invention, when the user's mobile phone receives an incoming call or is in use, the signal of line connection between the mobile phone and the telecommunication office or the computer host received by the antenna 31 of the second signal-processing unit 3 is sent to the first signal-processing unit 2, at where the received signal is encoded. The encoded signal is then sent to the computer host 1. With a supporting application, the encoded signal is used to inform the user that an incoming call is received or a call is in progress on his or her mobile phone.

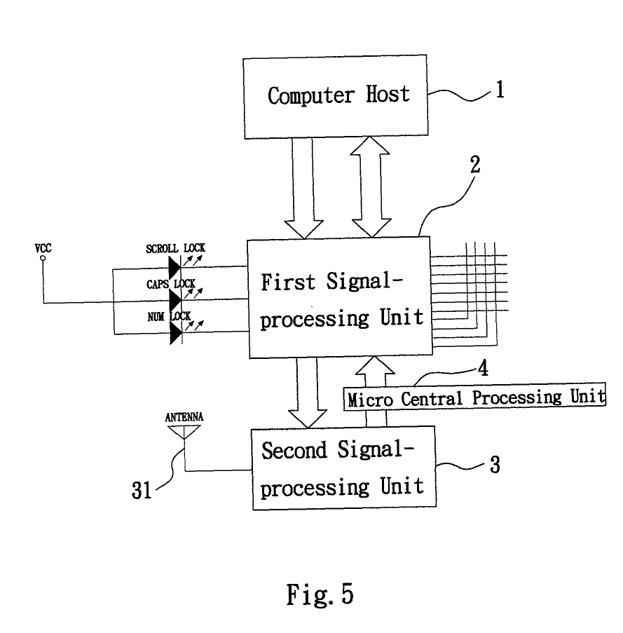

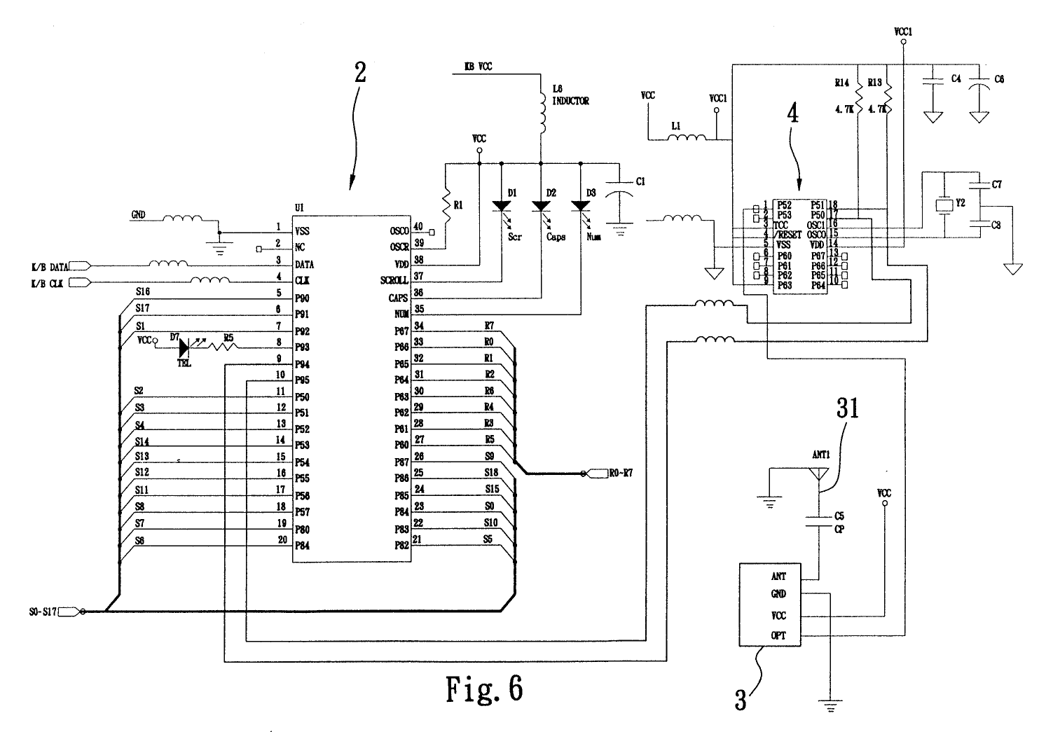

Please now refer to FIGS. 5 and 6 that are block and circuit diagrams, respectively, of a keyboard capable of informing user of incoming call according to a third embodiment of the present invention. As shown, the keyboard includes a first signal-processing unit 2 powered by a host 1 of a computer to which the keyboard is connected, so that bi-directional transmission of data between the computer host 1 and the first signal-processing unit 2 is possible. The keyboard is further internally provided with a second signal-processing unit 3 that is powered by the first signal-processing unit 2. The second signal-processing unit 3 has an input port ANT connected to an antenna 31, and an output port OPT connected to a micro central processing unit 4 for processing signals. When a user's mobile phone receives an incoming call or is in use, the antenna 31 of the second signal-processing unit 3 would receive a signal indicating a line connection between the mobile phone and a telecommunication office or the computer host 1. At this point, the micro central processing unit 4 decodes the incoming-call signal and sends the decoded signal to the first signal-processing unit 2 via a serial communication interface, and then to the computer host 1 via the keyboard interface. With a supporting application, the caller's number or the current status of the user's mobile phone can be shown on the screen of the computer to timely inform the user of such information.

In the present invention, the light emitting diodes 22, 32 may be replaced with liquid crystal displays (LCD).

With the keyboard of the present invention, a user concentrated in working on a computer can timely see flashes on the keyboard or message shown on the screen informing a call received by his or her mobile phone to avoid missing important calls or being scared by suddenly sounded ring signals.

What is claimed is:

1. A keyboard capable of informing user of incoming call, comprising a first signal-processing unit powered by a host of a computer to which said keyboard is connected, and a second signal-processing unit powered by said first signal-processing unit; said second signal-processing unit having an input port connected to an antenna for receiving an incoming-call signal, and an output port connected either to a display element or a buzzer for informing the user of an incoming call via lights or sounds, or to said first signal-processing unit for sending the received incoming-call signal to the host of the computer via said first signal-processing unit; and said received incoming-call signal sent to the computer host being shown on a screen of the computer via a supporting application.

2. The keyboard capable of informing user of incoming call as claimed in claim 1, wherein said display element is a light emitting diode.

3. The keyboard capable of informing user of incoming call as claimed in claim 1, wherein said display element is a liquid crystal display.
